(19) United States
(12) Patent Application Publication
(10) Pub. No.: US 2006/0064535 A1
(43) Pub. Date: Mar. 23, 2006

(54) Efficient multi-bank memory queuing system

(76) Inventor: Robert Michael Walker, Raleigh, NC (US)

Correspondence Address: QUALCOMM, INC, 5775 MOREHOUSE DR., SAN DIEGO, CA, 92121, US

(21) Appl. No.: 10/948,601

(22) Filed: Sep. 22, 2004

(51) Int. Cl. G06F 12/00

(52) U.S. Cl. 711/5

(57) ABSTRACT

Systems and techniques for queuing commands in a multi-banked memory is disclosed. The systems and techniques include storing and retrieving data from a memory over a bus. The memory may include a plurality of memory banks. In at least one embodiment of a system or technique to queue commands, a first bus operation may be initiated to an unopened page in a first one of the memory banks in response to a first command from a first memory queue, and a second bus operation may be performed to an opened page in a second one of the memory banks in response to a second command from a second memory queue while the unopened page in the first one of the memory banks is being opened.

### BACKGROUND

1. Field

The present disclosure relates generally to processing systems, and more specifically, to efficient multi-bank memory queuing systems.

2. Background

Computers typically employ one or more processors capable of communicating with memory over a bus. Memory is a storage medium that holds the programs and data needed by the processor to perform its functions. Recently, with the advent of more powerful software programs, the demands on memory have been increasing at an astounding rate. The result is that modern computers require a large amount of memory, which is inherently slower than the smaller memories. In fact, when it comes to access speed, processors are currently surpassing memory by an ever-increasing margin. This means that processors are increasingly having to wait for program instructions and data to be written to and read from memory.

One solution is to use a multi-bank memory. A multi-bank memory may be thought of as a series of separate memories integrated into the same piece of silicon. Each memory bank may be addressed individually by the processor as an array of rows and columns This means that the processor can read or write program instructions and/or data from each memory bank in parallel. The processor may perform a read operation to a particular memory bank by placing a “read command” on the bus instructing the memory bank to retrieve the program instructions and/or data from a block of memory beginning at a specific address. The processor may perform a write operation to a particular memory bank by placing a “write command” on the bus instructing the memory bank to store the program instructions and/or data sent with the write command to a block of memory beginning at a specific address.

A memory controller is used by the processor to manage access to the memory banks. The memory controller includes a queue that buffers the read and write commands, and executes each command in the order it is received. The delay associated with the execution of a command depends on whether or not the processor is attempting to access an open page in a memory bank. A “page” is normally associated with a row of memory, and an “open page” means that the memory bank is pointing to a row of memory and requires only a column address strobe from the memory controller to access the memory location. To access an unopened page of a memory bank, the memory controller must present a row address strobe to the memory bank to move the pointer before presenting a column address strobe. As a result, the latency of the computer may be adversely impacted when read and write commands from the queue require the memory controller to access an unopened page in one of the memory banks.

### SUMMARY

In one aspect of the present invention, a method of storing and retrieving data from a memory over a bus may be performed. The memory may have a plurality of memory banks. The method may include initiating a first bus operation to an unopened page in a first one of the memory banks in response to a first command from a first memory queue; and performing a second bus operation to an opened page in a second one of the memory banks in response to a second command from a second memory queue while the unopened page in the first one of the memory banks is being opened.

In another aspect of the present invention, a method of storing and retrieving data from memory over a bus may be performed. The memory may have a plurality of memory banks. The method may include receiving a first command to access a first one of the memory banks followed by a second command to access a second one of the memory banks; determining that a first memory queue for the first one of the memory banks is filled beyond a first threshold, and a second memory queue for the second one of the memory banks is filled below a second threshold; and sending the second command to the second memory queue before sending the first command to the first memory queue in response to such determination.

In yet another aspect of the present invention, a bus slave includes a memory having a plurality of memory banks; and a memory controller having a plurality of memory queues, each of the memory queues being configured to provide commands to a different one of the memory banks, the memory controller being configured to perform a bus operation to an open page in one or more of the memory banks while opening an unopened page in another one of the memory banks.

In a further aspect of the present invention, a processing system includes a memory having a plurality of memory banks; and a memory controller having a plurality of memory queues, each of the memory queues being configured to provide commands to a different one of the memory banks, and wherein each of the memory queues is further configured to generate a flag indicating whether it is filled beyond a threshold; a plurality of processors; and an arbiter configured to manage access to the memory banks by the processors as a function of the flags.

It is understood that other embodiments of the present invention will become readily apparent to those skilled in the art from the following detailed description, wherein various embodiments of the invention are shown and described by way of illustration. As will be realized, the invention is capable of other and different embodiments and its several details are capable of modification in various other respects, all without departing from the spirit and scope of the present invention. Accordingly, the drawings and detailed description are to be regarded as illustrative in nature and not as restrictive.

### BRIEF DESCRIPTION OF DRAWINGS

FIG. 1 is a conceptual block diagram illustrating an example of a processing system;

FIG. 2 is a conceptual block diagram illustrating an example of a bus slave in a processing system;

FIG. 3 is a flow diagram illustrating an example of a memory controller operating with memory in a bus slave; and

FIG. 4 is a conceptual block diagram illustrating an example of a processing system with a detailed depiction of a bus slave.

### DETAILED DESCRIPTION

The detailed description set forth below in connection with the appended drawings is intended as a description of various embodiments of the present invention and is not intended to represent the only embodiments in which the present invention may be practiced. The detailed description includes specific details for the purpose of providing a thorough understanding of the present invention. However, it will be apparent to those skilled in the art that the present invention may be practiced without these specific details. In some instances, well-known structures and components are shown in block diagram form in order to avoid obscuring the concepts of the present invention.

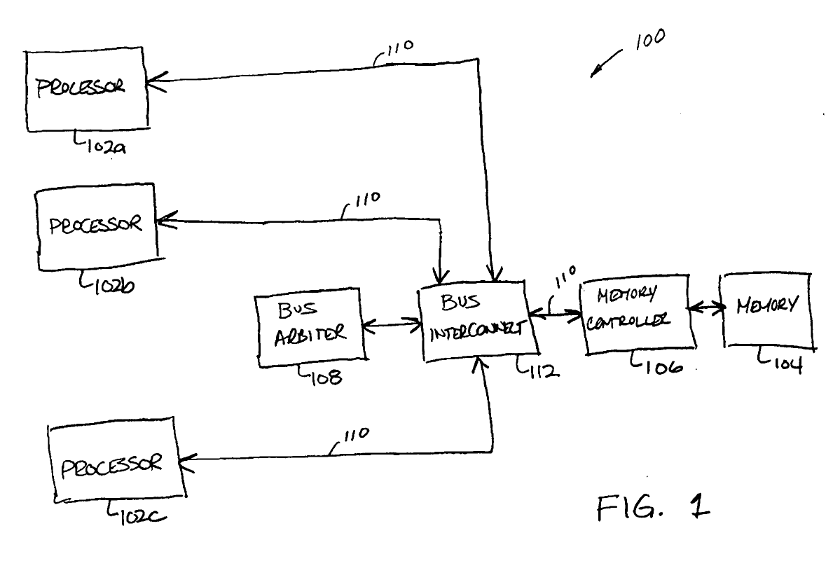

FIG. 1 is a conceptual block diagram illustrating an example of a processing system. The processing system 100 may be a computer, or resident in a computer, or any other system capable of processing, retrieving and storing information. The processing system 100 may be a stand-alone system, or alternatively, embedded in a device, such as a cellular telephone, a personal digital assistant (PDA), a personal computer (PC), a laptop, or the like.

The processing system 100 is shown with three processors 102a-102c that may access share memory 104 through a memory controller 106, but may be configured with any number of processors depending on the particular application and the overall design constraints. The processors 102a-102c may be any type of bus mastering component including, by way of example, a microprocessor, a digital signal processor (DSP), a bridge, programmable logic, discrete gate or transistor logic, or any other information processing component. The memory 104 may be a multi-bank memory, such as a synchronous dynamic random access memory (SDRAM), or any other multi-banked component capable of retrieving and storing information.

A bus arbiter 108 may be used to grant access to the memory 104 over a bus 110. The bus 110 may be implemented with point-to-point switching connections through a bus interconnect 112. In this configuration, the bus arbiter 108 configures the bus interconnect 112 to provide a direct connection between two components on the bus (e.g., the processor 102a and the memory 104). Multiple direct links within the bus interconnect 112 may be used to allow several components to communicate at the same time. Alternatively, the bus 110 may be implemented as a shared bus, or any other type of bus, under control of the bus arbiter 108. A shared bus provides a means for any number of components to communicate in a time division fashion.

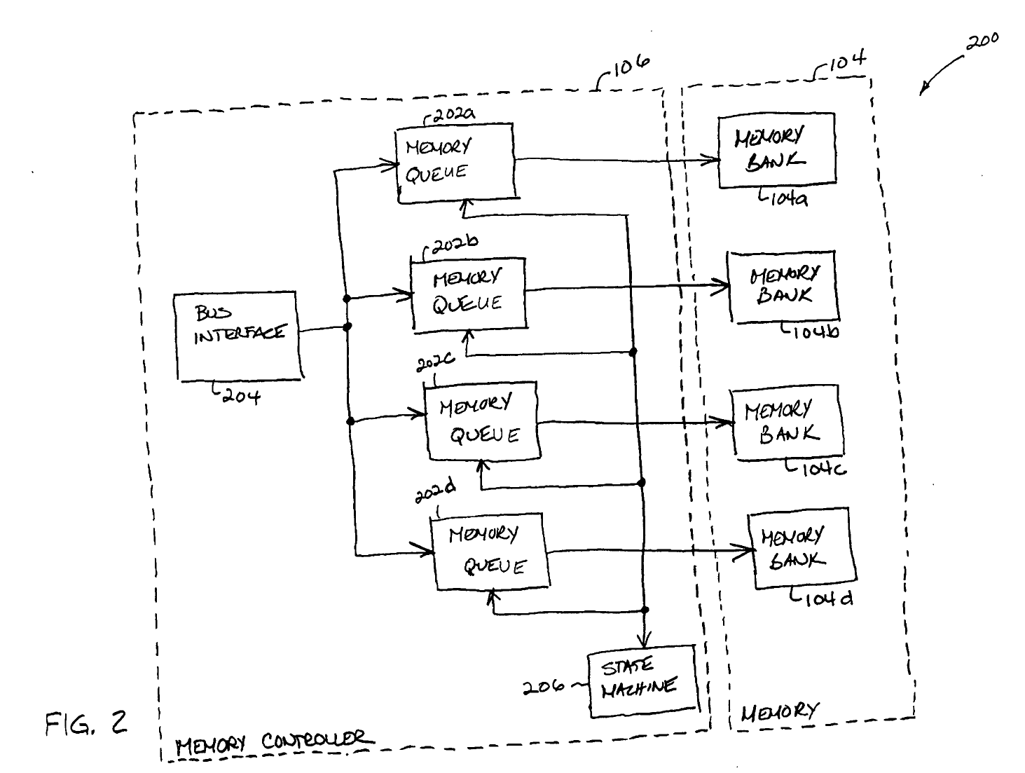

FIG. 2 is a conceptual block diagram illustrating an example of a bus slave. The bus slave 200 includes memory 104, which is shown with four banks 104a-104d, but may have any number of banks depending on the particular application and overall design constraints. The memory controller 106 may include a separate memory queue for each memory bank, and in this case, the memory controller 106 includes four memory queues 202a-202d. The memory queue may be a first-in, first-out (FIFO) device. For ease of explanation, only the memory queues for the read and write commands are shown with the understanding that the memory controller will also have queues for storing and retrieving program instructions and data to and from the memory banks. The memory controller 106 may also include an interface 204 to the bus 108. The bus interface 204 may be used to determine the destination memory bank for each of the commands received on the bus 108, and store that command in the appropriate memory queue. A state machine 206, or any other type of processing element, may be used to release the commands from the memory queues 202a-202d to the memory banks 104a-104d.

The state machine 206 may be configured to release commands from the memory queues 202a-202d in a sequence that tends to reduce latency. This may be achieved in a variety of ways. By way of example, the state machine 206 may present a command to one memory bank that requires a new page to be opened, but instead of remaining idle while the memory bank opens the new page, the state machine 206 may present commands to other memory banks that call for read and/or write operation to open pages.

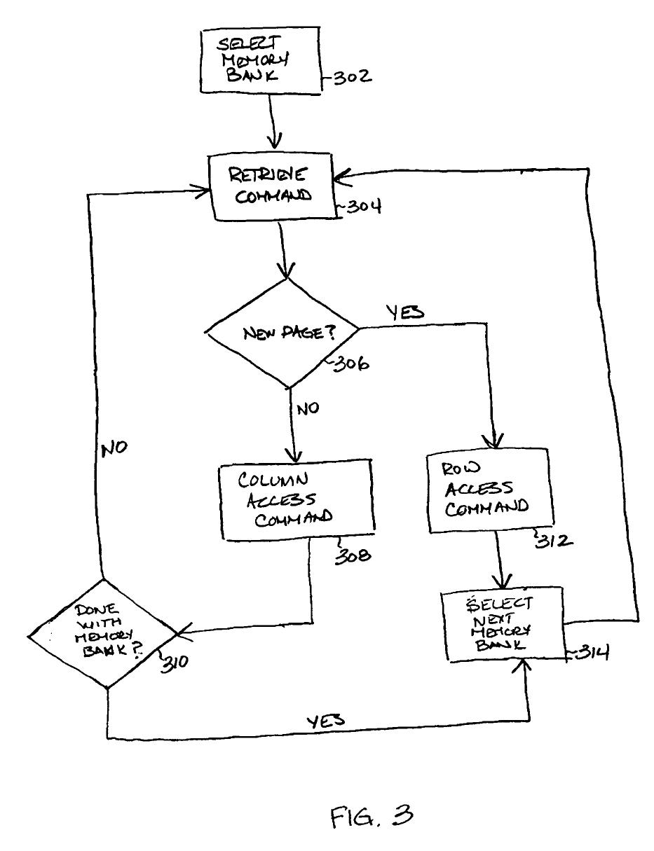

FIG. 3 is a flow diagram illustrating an example of the way the state machine releases commands from the memory queues to the memory banks. Those skilled in the art will appreciate that the state machine may be operated in any number of ways to perform read and/or write operations to and from open pages in one or more memory banks, while at the same time opening new pages in one or more other memory banks. In this example, the state machine may select a memory bank to perform read and/or write operations in step 302. The selection may be arbitrary, or alternatively, may be based on some selection criteria. By way of example, the state machine may select a memory bank based on a priority and/or fairness scheme. Alternatively, the state machine may select a memory bank in which the next read or write operation in the corresponding memory queue is to a page that is currently opened or unopened. In any event, once the state machine selects a memory bank, it may retrieve a command from the corresponding memory queue in step 304, and determine, if it has not already done so, whether the command requires a read or write operation to an opened page in step 306. If the command requires a read or write operation to the page currently opened in the selected memory bank, then the state machine presents a column address strobe to the selected memory bank in step 308 to perform the required read or write operation.

Once the required read or write operation is performed, the state machine may determine whether to perform another read or write operation from the selected memory bank in step 310. This determination may be based on any selection scheme. By way of example, the state machine may perform another read or write operation from the selected memory bank, provided that a maximum number of consecutive read and/or write operations have not already been performed to and from the selected memory bank. The maximum number may be static or dynamic, and it may be the same for each memory bank or it may be different. In some embodiments, the maximum number may be based on consecutive read and/or write operations by the same processor. In other embodiments, there may not be a maximum number at all, and the memory controller may perform any number of consecutive read and/or write operations to the same page in a memory bank. In any event, if the state machine determines that it is done performing read and/or write operations from the selected memory bank, then it may select another memory bank in step 314. Conversely, if the state machine determines that it should perform more read and/or write operations from the selected memory bank, it may loop back to step 304 to retrieve the next command from the memory queue for the selected memory bank.

Depending on the selection scheme or criteria used by the state machine, and the current state of the memory queue for the selected memory bank, the state machine may end up performing a number of consecutive read and/or write operations until it retrieves a command from the memory queue for the selected memory bank requiring a read or write operation to a new page in step 306. When this occurs, the state machine may present a row address strobe to the selected memory bank in step 312 to open the new page. However, instead of remaining idle while the new page is being opened, the state machine may select a new memory bank in step 314 in search of read and/or write commands that can be performed to open pages in the other memory banks.

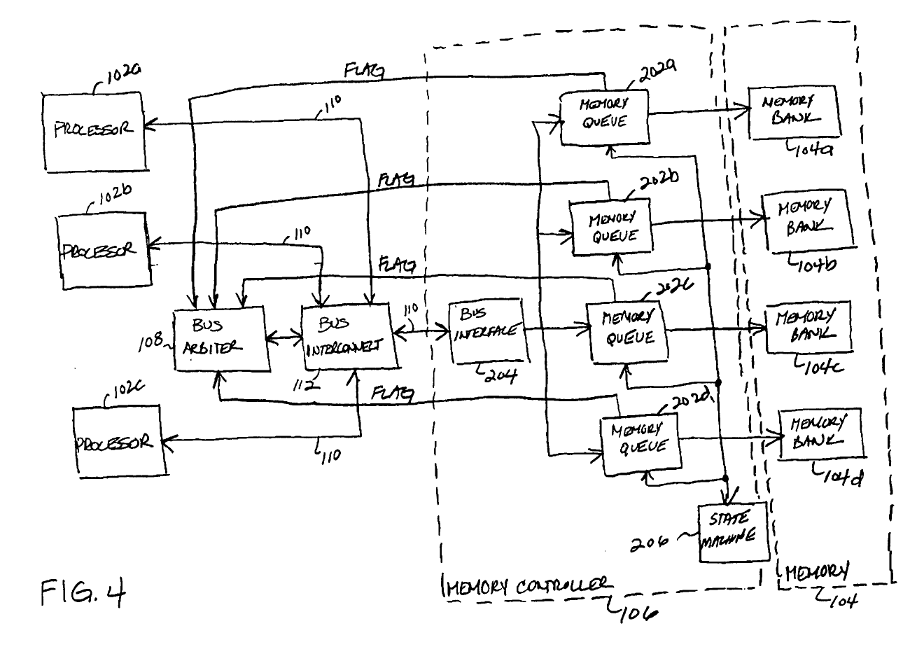

FIG. 4 is a conceptual block diagram illustrating an example of a processing system with a detailed depiction of the bus slave. The bus arbiter 108 may be used to manage access to the memory 104 by the processors 102a-102c. In one embodiment of the bus arbitrator 108, the processing components 102a-102c may broadcast commands, along with the associated program instructions and/or data, to the bus arbiter 108. The bus arbiter 108 may determine the sequence in which the commands, and associated program instructions and data, will be provided to the memory 104 and dynamically configure the bus interconnect 112 accordingly. In another embodiment of the bus arbiter 108, the processors 102a-102c may request access to the bus 110, and the bus arbiter 108 may determine the sequence in which the requests will be granted, again, by dynamically reconfiguring the interconnect 110. In either case, the bus arbiter 108 determines the sequence in which the commands, and associated program instructions and data, are provided to the memory 104 based on a bus arbitration scheme. The bus arbitration scheme may vary depending on the specific application, and the overall design constraints, but will generally try to balance some kind of priority system with a fairness criteria.

The bus arbitration scheme may be optimized by considering the state of each memory queue 202a-202d in the memory controller 106. Preferably, the bus arbitration scheme should be configured to recognize when a memory queue is full, or almost full, and provide commands, as well as program instructions and data, from the various processors to other memory queues when this occurs. If the bus arbiter 108 keeps providing commands, data, and/or program instructions to the same memory queue, a backlog condition may develop, causing the processing system to slow down or even stall.

In at least one embodiment of the of the memory controller 106, each memory queue 202a-202d may supply a flag to the bus arbiter 108 indicating whether or not the queue is almost full. The exact threshold used to trigger the flag may depend on various factors including the specific application, the performance requirements, and the overall design constraints. In some embodiments the flag may be triggered when the memory queue is completely full, but this may result in a more limiting design. Regardless, the flag tells the bus arbiter 108 whether or not to grant access to a processor that wants access to a specific memory bank. When the flag indicates that a memory queue for a particular memory bank is almost full, the bus arbitrator 108 should provide access to only those processors with commands directed to other memory banks. This approach will not only keep the processing system from stalling, but is also more likely to provide the memory controller 106 with a distribution of commands to increase the probability that the state machine 206 will be able to locate read and/or write commands to open pages in the memory bank, while opening a new page in another memory bank.

As discussed earlier, the bus arbiter 108 may determine the sequence in which the commands are provided to the memory 104 based on any bus arbitration scheme. When the bus arbiter 108 prepares to send a command from one of the processors, it determines the appropriate memory queue and checks its flag. If the flag indicates that the memory queue is filled below some threshold, the bus arbiter 108 may release the command to that memory controller 106 queue. If, on the other hand, the flag indicates that the memory queue is full, or almost full, then the command will not be released to the memory controller 104. Instead, the command will be delayed until all other pending commands to memory queues that are filled below the threshold are sent. Alternatively, the command may be simply held until the flag indicates that its destination memory queue is no longer full, or almost full. In some embodiments of the bus arbiter 108, the bus arbitration scheme may be forward looking. That is, the flag for each memory queue may be continuously monitored and the sequence of commands sent to the memory controller 106 dynamically optimized based on the current state of the flags. In any event, by using handshaking techniques between the bus arbiter 108 and the memory queues 202a-202d, the bus arbiter 108 may decide which processors 102a-102c to grant access to the memory controller 106 and which processors 102a-102b to deny access.

The various illustrative logical blocks, modules, circuits, elements, and/or components described in connection with the embodiments disclosed herein may be implemented or performed with a general purpose processor, a digital signal processor (DSP), an application specific integrated circuit (ASIC), a field programmable gate array (FPGA) or other programmable logic component, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing components, e.g., a combination of a DSP and a microprocessor, a plurality of microprocessors, one or more microprocessors in conjunction with a DSP core, or any other such configuration.

The methods or algorithms described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor can read information from, and write information to, the storage medium. In the alternative, the storage medium may be integral to the processor.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein, but is to be accorded the full scope consistent with the claims, wherein reference to an element in the singular is not intended to mean “one and only one” unless specifically so stated, but rather “one or more.” All structural and functional equivalents to the elements of the various embodiments described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of storing and retrieving data from a memory over a bus, the memory having a plurality of memory banks, comprising:
initiating a first bus operation to an unopened page in a first one of the memory banks in response to a first command from a first memory queue; and
performing a second bus operation to an opened page in a second one of the memory banks in response to a second command from a second memory queue while the unopened page in the first one of the memory banks is being opened.

2. The method of claim 1 wherein the first bus operation is initiated by providing a row address strobe to the first one of the memory banks, and wherein the second bus operation is performed by providing a column address strobe to the second one of the memory banks.

3. The method of claim 1 further comprising completing the first bus operation following the performance of the second bus operation.

4. The method of claim 3 wherein the first bus operation is initiated by providing a row address strobe to the first one of the memory banks, and the first bus operation is completed by providing a first column address strobe to the first one of the memory banks, and wherein the second bus operation is performed by providing a second column address strobe to the second one of the memory banks.

5. The method of claim 3 further comprising performing a third bus operation to an opened page in a third one of the memory banks in response to a third command from a third memory queue while the unopened page in the first one of the memory banks is being opened, and completing the first bus operation following the performance of the third bus operation.

6. The method of claim 3 further comprising initiating a third bus operation to an unopened page in a third one of the memory banks in response to a third command from a third memory queue following the completion of the first bus operation.

7. The method of claim 1 further comprising a third memory queue for a third one of the memory banks, the method further comprising evaluating a third command from the third memory queue and the second command from the second memory queue while the unopened page in the first one of the memory banks is being opened, and determining to perform the second bus operation based on such evaluation.

8. The method of claim 1 further comprising receiving the first and second commands from the bus, and placing the first command in the first memory queue and the second command in the second memory queue.

9. The method of claim 8 further comprising determining that the first memory queue is filled below a threshold, and sending the first command to the first memory queue over the bus in response to such determination.

10. A method of storing and retrieving data from memory over a bus, the memory having a plurality of memory banks, comprising:
receiving a first command to access a first one of the memory banks followed by a second command to access a second one of the memory banks;
determining that a first memory queue for the first one of the memory banks is filled beyond a first threshold, and a second memory queue for the second one of the memory banks is filled below a second threshold; and
sending the second command to the second memory queue before sending the first command to the first memory queue in response to such determination.

11. The method of claim 10 wherein the sending of the first command to the first memory queue is delayed until the first memory queue becomes filled below the first threshold.

12. The method of claim 11 further comprising receiving a third command to access a third one of the memory banks before the first memory queue becomes filled below the first threshold, determining that a third memory queue for the third one of the memory banks is filled below a third threshold, and sending the third command to the third memory queue before sending the first command to the first memory queue.

13. The method of claim 11 further comprising receiving a third command to access a third one of the memory banks before the first memory queue becomes filled below the first threshold, determining that a third memory queue for the third one of the memory banks is filled beyond a third threshold, and delaying sending of the third command to the third memory queue until the third memory queue becomes filled below the third threshold.

14. A bus slave, comprising:
a memory having a plurality of memory banks; and
a memory controller having a plurality of memory queues, each of the memory queues being configured to provide commands to a different one of the memory banks, the memory controller being configured to perform a bus operation to an open page in one or more of the memory banks while opening an unopened page in another one of the memory banks.

15. The bus slave of claim 14 wherein the memory controller is further configured to perform the bus operation to the open page in each of the one or more memory banks by providing a column address strobe to each, and wherein the memory controller is further configured to open the unopened page in said another one of the memory banks by providing a row address strobe thereto.

16. The bus slave of claim 14 wherein the memory controller is further configured to complete a bus operation to said another one of the memory banks when the unopened page is opened.

17. The bus slave of claim 16 wherein the memory controller is further configured to perform the bus operation to the open page in each of the one or more memory banks by providing a row address strobe to each, and wherein the memory controller is further configured to open the unopened page in said another one of the memory banks by providing a column address strobe thereto, and completing the bus operation to said another one of the memory banks when the unopened page is opened by providing a column address strobe thereto.

18. The bus slave of claim 14 wherein the memory controller is further configured to determine the one or more of the memory banks to perform the respective bus operations while opening the unopened page in said another one of the memory banks from a pending command in each of the one or more memory bank's memory queue.

19. The bus slave of claim 14 wherein each of the memory queues is configured to generate a flag indicating whether it is filled beyond a threshold.

20. The bus slave of claim 14 wherein the memory comprises a SDRAM.

21. A processing system, comprising:
a memory having a plurality of memory banks; and
a memory controller having a plurality of memory queues, each of the memory queues being configured to provide commands to a different one of the memory banks, and wherein each of the memory queues is further configured to generate a flag indicating whether it is filled beyond a threshold;
a plurality of processors; and
an arbiter configured to manage access to the memory banks by the processors as a function of the flags.

22. The processing system of claim 21 wherein the arbiter is further configured to manage access to the memory banks by providing to the memory controller only those commands generated by the processors that are destined for one of the memory queues that has its flag set to indicate that it is filled below the threshold.

23. The processing system of claim 21 wherein the memory controller is further configured to perform a bus operation to an open page in one or more of the memory banks while opening an unopened page in another one of the memory banks.

24. The processing system of claim 23 wherein the memory controller is further configured to perform the bus operation to the open page in each of the one or more memory banks by providing a column address strobe to each, and wherein the memory controller is further configured to open the unopened page in said another one of the memory banks by providing a row address strobe thereto.

25. The processing system of claim 23 wherein the memory controller is further configured to complete a bus operation to said another one of the memory banks when the unopened page is opened.

26. The processing system of claim 25 wherein the memory controller is further configured to perform the bus operation to the open page in each of the one or more memory banks by providing a row address strobe to each, and wherein the memory controller is further configured to open the unopened page in said another one of the memory banks by providing a column address strobe thereto, and completing the bus operation to said another one of the memory banks when the unopened page is opened by providing a column address strobe thereto.

27. The processing system of claim 23 wherein the memory controller is further configured to determine the one or more of the memory banks to perform the respective bus operations while opening the unopened page in said another one of the memory banks from a pending command in each of the one or more memory bank's memory queue.

28. The processing system of claim 21 wherein the memory comprises a SDRAM.
